(19) United States
(12) Patent Application Publication
(10) Pub. No.: US 2008/0036764 A1
(43) Pub. Date: Feb. 14, 2008

(54) METHOD AND APPARATUS FOR PROCESSING COMPUTER GRAPHICS DATA

(75) Inventors: Young Jin CHUNG, Seoul (KR); Kil Whan LEE, Seoul (KR)

Correspondence Address: VOLENTINE & WHITT PLLC, ONE FREEDOM SQUARE, 11951 FREEDOM DRIVE SUITE 1260, RESTON, VA, 20190, US

(73) Assignee: SAMSUNG ELECTRONICS CO., LTD., Gyeonggi-do (KR)

(21) Appl. No.: 11/828,538

(22) Filed: Jul. 26, 2007

(30) Foreign Application Priority Data
Aug. 11, 2006 (KR) 10-2006-0076063

(51) Int. Cl. G06T 15/40

(52) U.S. Cl. 345/422

(57) ABSTRACT

An apparatus for processing computer graphics data includes a perfragment unit performing a depth test with respect to a present fragment of graphics data, and a cache controller that prefetches a color value of the present fragment from an external memory device to a cache memory while the perfragment unit performs the depth test of the present fragment.

### CROSS-REFERENCE TO RELATED APPLICATION

This U.S. non-provisional patent application claims priority under 35 U.S.C. § 119 of Korean Patent Application No. 2006-0076063 filed on Aug. 11, 2006, the entire contents of which are hereby incorporated by reference in its entirety.

### BACKGROUND OF THE INVENTION

1. Field of the Invention

Embodiments of the invention relate to computer graphics data processing technology. More particularly, embodiments of the invention relate to a method and apparatus for processing computer graphics data which can prefetch a color value used for a next pipeline in the middle of a depth/stencil test.

2. Discussion of Related Art

In designing a 3D graphics accelerator used in various types of displays, access time to an external memory device or a frame buffer (hereinafter, referred to as the “external memory access time”) is the most influential factor in providing real time performance. FIG. 1 is a block diagram of a general 3D graphics accelerator 100 including a 3D graphics pipeline 110 and frame buffer 120. FIG. 2 shows the pipeline process of the perfragment unit 114 and the cache controller 115 shown in FIG. 1. When the 3D graphics accelerator 100 reads necessary data from an external memory device 120 to perform texturing, alpha blending, and a depth test, the associated graphics pipeline 110 stalls. To compensate for this stall time, external memory access time must be reduced.

The 3D graphics accelerator 100 uses a texture cache memory 117, a Z cache memory or a depth/stencil cache memory 121, and a color cache memory 122 to reduce this external memory access time. Perfragment unit 114 performs fragment processing and accesses the external memory device 120 many times to perform the depth test and alpha blending. Thus, the 3D graphics accelerator 100 uses the Z cache memory 121 and the color cache memory 122. When the 3D graphics accelerator 100 renders a scene in real time, various textures and a variety of color blending methods are used to obtain a more natural and smooth image. Also, a variety of cache memories are used to improve the performance of the 3D graphics accelerator during real time rendering. For example, a texture cache memory 117 is utilized for texture filtering. The color cache memory 122 is utilized for alpha blending, and the depth/stencil cache memory 121 is utilized for a depth and stencil test. These cache memories 117, 121, and 122 are used to prevent stalling of the graphics pipeline of the 3D graphics accelerator 100 due to a long latency when the 3D graphics accelerator 100 accesses the external memory device 120 such that the perfragment unit 114 accesses the external memory device several times. By improving the performance of the depth/stencil cache memory 121 and color cache memory 122, the performance of the 3D graphics accelerator is likewise improved.

The perfragment unit 114 sequentially performs operations such as a pipeline operation which includes a scissor test, an alpha test, depth/stencil value read, a stencil test, a depth test, a stencil operation, depth/stencil value write, color value read, alpha blending, a logical operation, dithering/color format conversion, and color value write as shown in FIG. 2. As a result of this sequence, pixel colors are generated and stored in the external memory device or the frame buffer 120. Because the external memory 120 is accessed during the depth test, a conventional perfragment unit 114 reads a depth/stencil value of a pixel from the depth/stencil cache memory 121 in cache controller 115 (in case of cache hit) or from the depth/stencil memory 123 of the frame buffer 120 (in case of cache miss) and performs the depth test, stencil test, and stencil operation. When the depth/stencil test passes, a new depth value is stored in depth/stencil memory 123. Next, the perfragment unit 114 reads a color value of the pixel from the color cache memory 122 of cache controller 115 (in case of cache hit) or from the color memory 124 of the frame buffer 120 (in case of cache miss) through the pipeline. Perfragment unit 114 performs the alpha blending, logical operation, dithering, and color format conversion and the resulting color value is stored in color memory 124. When the pipeline of the perfragment unit is stalled, the perfragment unit 114 reads a depth value and a stencil value from the depth/stencil cache memory 121 (cache hit) or the depth/stencil memory 123 (cache miss) for the depth test. The pipeline of the perfragment unit 114 is stalled again during which the perfragment unit 114 reads a color value from the color cache memory 122 (cache hit) or the color memory 124 (cache miss) for alpha blending. The external memory devices 120 employed with the 3D graphics accelerator 100 utilize a DRAM whose initial access latency is relatively long. Examples of such DRAMS include, for example, SDRAMs, DDRs, SDRAMs, or mobile DDR SDRAMs. Thus, stall time associated with the pipeline for external memory access influences the overall performance of the 3D graphics accelerator. In addition, since conventional 3D graphics accelerators perform the color operation for color blending only after all operations for the depth/stencil test are complete, the perfragment unit stall time deteriorates the performance of the 3D graphics accelerator.

### SUMMARY OF THE INVENTION

Embodiments of the present invention are directed to a method for processing computer graphics data to reduce external memory access time of a 3D graphics accelerator. An embodiment of the method includes performing a depth test using a perfragment unit with respect to a present fragment of associated graphics data. A color value of the present fragment is prefetched from an external memory device. The prefetched color value is supplied to a cache memory while the depth test of the present fragment is performed.

In an embodiment of the apparatus for processing computer graphics data includes a perfragment unit, a cache controller communicating with the perfragment unit and a cache memory. The perfragment unit performs a depth test with respect to a present fragment of graphics data. The cache controller is configured to prefetch a color value of the present fragment from an external memory device. The cache memory receives the color value from the cache controller while the perfragment unit performs the depth test of the present fragment.

### BRIEF DESCRIPTION OF THE DRAWINGS

FIG. 1 is a functional block diagram of the general 3D graphics accelerator;

FIG. 2 illustrates the pipeline process of a perfragment unit and a cache controller shown in FIG. 1;

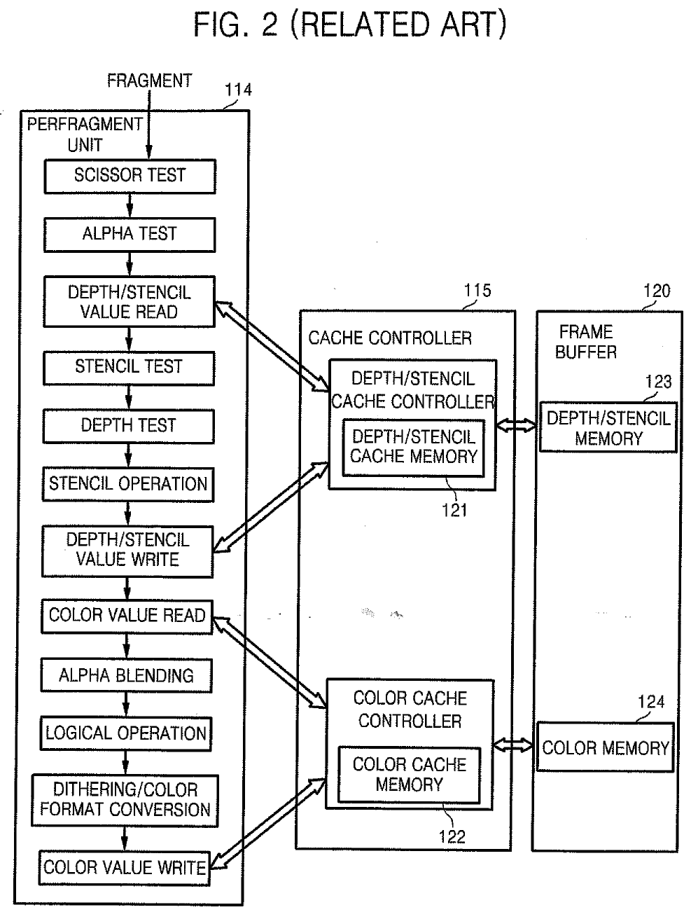

FIG. 3 illustrates the pipeline process of a perfragment unit and a cache controller according to an embodiment of the present invention; and

FIG. 4 is a flow chart for explaining the prefetch of a color value according to an embodiment of the present invention.

### DESCRIPTION OF EMBODIMENTS

The present invention will now be described more fully hereinafter with reference to the accompanying drawings, in which preferred embodiments of the invention are shown. This invention, however, may be embodied in many different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements throughout.

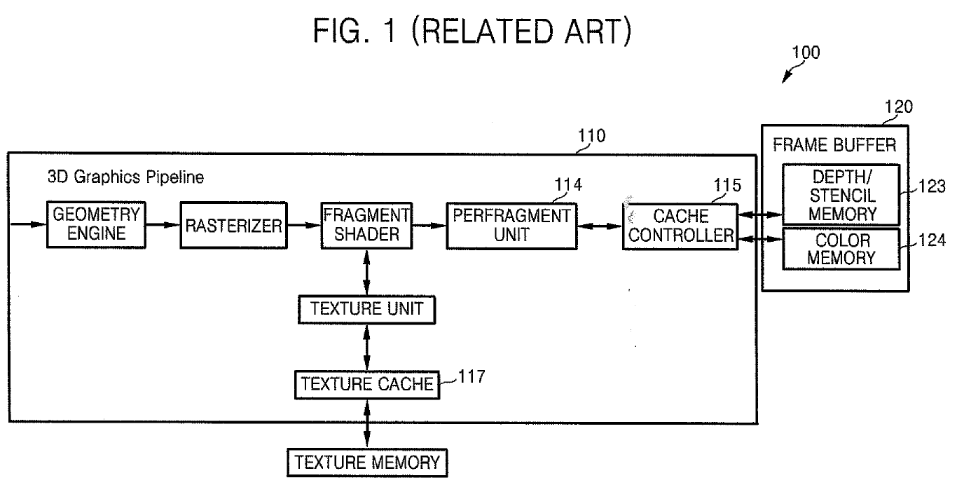

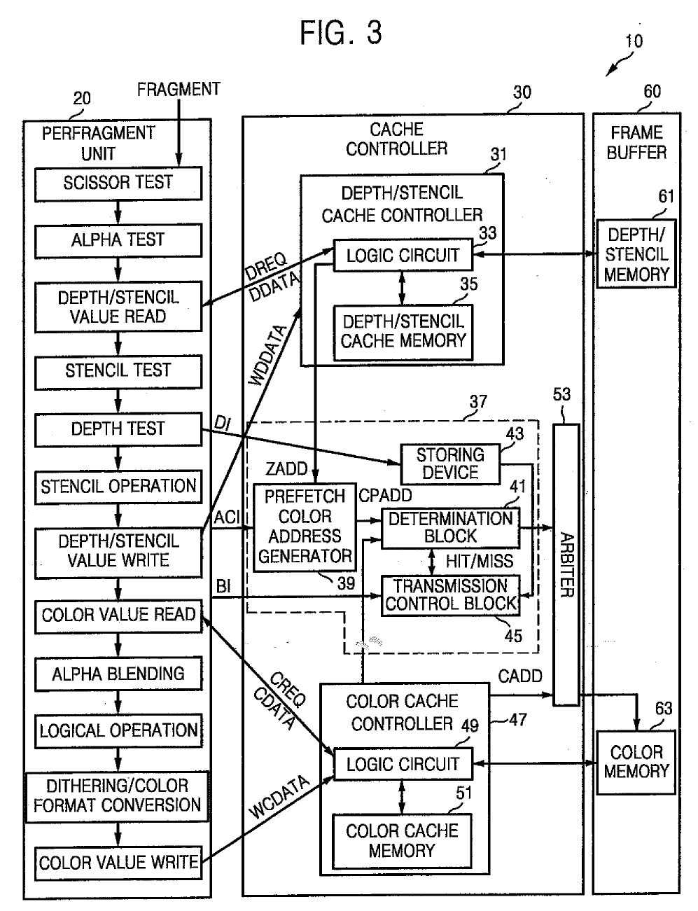

FIG. 3 illustrates computer system 10 that includes a perfragment unit 20, a cache controller 30, and a frame buffer 60 which is an external memory device. An apparatus for processing computer graphics data such as a 3D graphics accelerator is defined by the perfragment unit 20 and cache controller 30. Computer system 10 may further include a geometry engine 111, a rasterizer 112, a fragment shader 113, and a texture unit 116 shown with reference to FIG. 1. Perfragment unit 20 sequentially performs one or more operations such as a scissor test, an alpha test, depth/stencil value read, a stencil test, a depth text, a stencil operation, depth/stencil value write, color value read, alpha blending, a logical operation, dithering/color format conversion, and a color value write operation. Cache controller 30 includes a depth/stencil cache controller 31 having a logic circuit 33 and a depth/stencil cache memory 35, a prefetch block 37. The color cache controller 47 includes a logic circuit 49 and color cache memory 51. The cache controller 30 can further include an arbiter 53.

During a depth value read operation of a present fragment or present pixel, perfragment unit 20 outputs a plurality of signals DREQ. The DREQ signals include a depth value request, a depth address, and a read command sent to depth/stencil cache controller 31 to perform the depth value read operation. Logic circuit 33 of the depth stencil cache controller 31 compares a tag stored in the depth/stencil cache memory 35 with a received depth address in response to the DREQ signals including the depth request, depth address, and read command. When the data or depth value corresponding to the depth address is stored in the depth/stencil cache memory 35, this is considered a cache hit. Logic circuit 33 of the depth/stencil cache controller 31 outputs data DDATA read from depth/stencil cache memory 35 to perfragment unit 20 in response to the cache hit. However, when data corresponding to the depth address is not stored in the depth/stencil cache memory 35, this is considered a cache miss. Logic circuit 33 of the depth/stencil cache controller 31 outputs data DDATA corresponding to the depth address read from depth/stencil memory 61 of frame buffer 60 to perfragment unit 20 in response to the cache miss. The perfragment unit 20 is stalled until data DDATA corresponding to the depth address is received from cache controller 30.

The read operation of perfragment unit 20 of stencil data, a stencil value from the depth/stencil cache memory 35 or the depth/stencil memory 61 for a stencil test is similar to the read operation of the depth data or depth value from the depth/stencil cache memory 35 or the depth/stencil memory 61 for a depth test. Accordingly, a detailed description thereof is omitted. The perfragment unit 20 receives the depth value or stencil value of the present fragment and performs the depth test or stencil test with respect to the present fragment. While the depth test or stencil test of the present fragment is performed by perfragment unit 20, cache controller 30 prefetches a color value or color data of the present fragment from color memory 63 associated with frame buffer 60 to color cache memory 51. That is, while the perfragment unit 20 performs the depth/stencil value read, stencil test, depth test, stencil operation, and depth/stencil value write with respect to the present fragment, cache controller 30 prefetches the color value of the present fragment before the blending operation is performed. When the blending operation is performed, the cache miss generated in color cache controller 47 is decreased and the hit ratio generated in color cache controller 47 is increased. Since the stall time of the pipeline of the apparatus for processing computer graphics data is reduced, the 3D rendering performance of the computer graphics data processing apparatus is consequently improved.

When a system utilizes a bus supporting multiple outstanding transactions, a request can be made before the previous request is processed by an external memory device, for example, a DRAM. Accordingly, when cache controller 30 outputs a color cache miss request in advance during a depth cache miss, since the initial setting time of the external memory device is reduced, cache controller 30 can prefetch a color value. Thus, cache controller 30 essentially hides the initial external memory access time so that the memory controller effectively requests data from the external memory device having a plurality of banks through bank interleaving.

The depth cache miss is generated when the depth value corresponding to the depth address is not stored in depth/stencil cache memory 35. The color cache miss request is generated when the color value corresponding to a prefetch color address related to the depth address or the color value corresponding to the color address is not stored in color cache memory 51. The color value corresponding to the prefetch color address or the color value corresponding to the color address is requested by color memory 63. In addition, logic circuit 33 of depth/stencil cache controller 31 transmits depth address ZADD to a prefetch color address generator 39. Prefetch color address generator 39 generates prefetch color address CPADD based on address conversion information (ACI) as well as the depth address ZADD of the present fragment for which the depth test is presently performed. The prefetch color address CPADD is an address stored in color memory 63 and used to prefetch the color value of the fragment for which the depth test/stencil test is presently performed. For example, the ACI output from perfragment unit 20 includes at least depth value precision, stencil value precision, format of color memory 63, an offset of depth/stencil memory 61, or an offset of color memory 63. Depth/stencil memory 61 is referred to as a depth/stencil buffer and color memory 63 is referred to as a color buffer. The ACI can be information about the format of frame buffer 60 and the size of depth/stencil memory 61; and/or it can be information on the memory map of frame buffer 60.

TABLE 1

| Depth/ | | | | | |
|---|---|---|---|---|---|
| stencil | Color | Basic setting | | Cache read address | |
| value | memory | depth memory | Color memory | Depth | Generated prefetch |
| precision | format | offset | offset | address | color address |
| 32-bit | 16-bit | 0x10000000 | 0x20000000 | 0x10001000 | 0x20000800 |
| | 32-bit | | | 0x10001000 | 0x20001000 |

By way of example, Table 1 shows that when the depth/stencil value precision is 32 bits and the format of the color memory 63 is 32 bits, the prefetch color address generator 39 converts the offset (or base address) of depth/stencil memory 61 to the offset (or base address) of the color memory 63 to generate the prefetch color address CPADD from depth address ZADD. However, when the format of the color memory 63 is 16 bits, prefetch color address generator 39 makes a 1-bit right shift excluding the offset of color memory 63 to generate the prefetch color address CPADD from the depth address ZADD. The prefetch color address CPADD includes the base address and a pixel address. Thus, the prefetch color address generator 39 receives the depth address ZADD and the ACI, converts the offset of the depth/stencil memory 61 to the offset of the color memory 63, and generates the prefetch color address CPADD based on a difference between the depth/stencil value precision and the format of the color memory 63.

Determination block 41 determines whether a cache hit or cache miss has occurred based on the tag stored in color cache memory 51 and the prefetch color address CPADD. Determination block 41 controls the transmission of the prefetch color address CPADD to color memory 63 when there is a cache miss. When a cache hit occurs, since a color value corresponding to the prefetch color address CPADD is stored in color cache memory 51, there is no need to prefetch the color value. Cache controller 30 further includes a storing device 43 and a transmission control block 45. Storing device 43 stores the result of a depth test of a previous fragment or pixel. When the depth test of the previous fragment failed, there is no need to prefetch the color value of the present fragment because the depth test of the present fragment is likely to fail according to the pipeline process. Consequently, prefetch of the color value of the fragment is not needed.

Transmission control block 45 determines whether the color value is prefetched. When a user programs the device not to perform, for example, a color operation, an alpha blending operation or a logical operation, cache controller 30 doesn't need to prefetch the color value of the present fragment receiving a depth test or stencil test. When the color value corresponding to the prefetch color address CPADD is stored in color cache memory 51, cache controller 30 does not need to prefetch the color value of the present fragment. Additionally, when the depth test of the previous fragment failed, the depth test of the present fragment is likely to fail and there is no need to prefetch the color value of the present fragment. Thus, transmission control block 45 controls whether to transmit the prefetch color address CPADD to color memory 63 of frame buffer 60 based on at least one of (a) the existence of the color operation output from perfragment unit 20 (BI), (b) the success or failure of the depth test of the previous fragment output from storing device 43, or (c) the existence of the cache miss output from determination block 41. The prefetch color address CPADD is output from determination block 41 or transmission control block 45. Color memory 63 outputs the color value corresponding to the prefetch color address CPADD to logic circuit 49 of color cache controller 47. Logic circuit 49 stores the color value in color cache memory 51. Since the perfragment unit 20 can use the color value stored in color cache memory 51 during the blending operation, the time for which the pipeline is stalled during the blending operation is reduced.

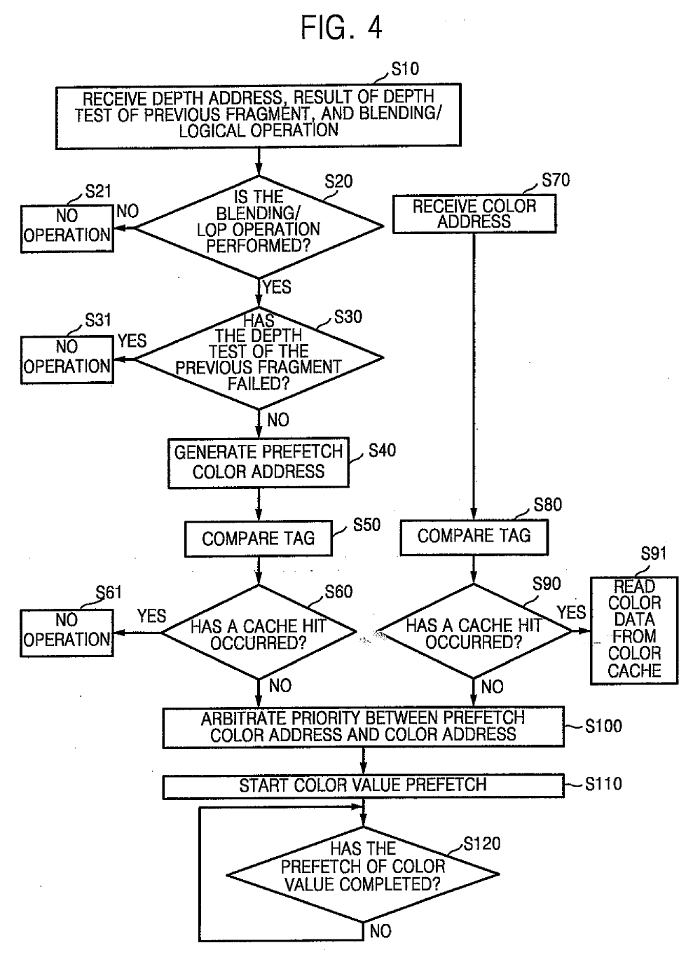

FIG. 4 is a flow chart for explaining the prefetch of a color value according to an embodiment of the present invention (reference is also made to FIG. 3). At step S10, cache controller 30 receives from perfragment unit 20, a depth address ZADD, a result of the depth test of the previous fragment, or a color operation control signal BI indicating whether a blending operation or logical operation LOP has been performed. A determination is made at step S20 whether the blending or logical operation was performed. When perfragment unit 20 does not perform the blending operation or logical operation, the process proceeds to step S21. Cache controller 30 does not prefetch the color value of the present fragment from color memory 63 to color cache memory 51 based on the BI output from perfragment unit 20. When perfragment unit 20 does perform the blending or logical operation, the process proceeds to step S30 where a determination is made whether the depth test of the previous fragment failed. If the depth test of the previous fragment failed, the process proceeds to Step S31 and cache controller 30 does not prefetch the color value of the present fragment from color memory 63 to color cache memory 51 at step S31. If the depth test of the previous fragment did not fail, prefetch color address generator 39 of cache controller 30 generates a prefetch color address CPADD based on the depth address ZADD and the ACI at step S40.

At step S50, determination block 41 of cache controller 30 receive the CPADD and compares a tag stored in color cache memory 51 with the received CPADD to determine whether a cache hit or cache miss has occurred. A determination is made at step S60 whether or not a cache hit occurred. When the cache hit occurs, cache controller 30 does not prefetch the color value of the present fragment from color memory 63 to color cache memory 51 at step S61. If a cache hit did not occur (i.e. a cache miss) the process proceeds to step S100. Depending on the priority determination made at step S100, cache controller 30 may start to prefetch the color value of the present fragment for which the depth test or stencil test is being performed by perfragment unit 20 from color memory 63 to color cache memory 51 at step S110. A determination is made at step S120 whether color cache memory 51 is full of the color value corresponding to the CPADD. If yes then the prefetch of the color value is complete (S120).

Logic circuit 49 of color cache controller 47 receives a color address CADD output from perfragment unit 20 at step S70. Step S80 compares the received CADD with the tag stored in color cache memory 51. At step S90, a determination is made whether a cache hit occurred. When the cache hit occurs, logic circuit 49 of color cache controller 47 reads a color value corresponding to the CADD from color cache memory 51 and outputs the read color value to the perfragment unit 20 at step S91. However, when the cache miss occurs, logic circuit 49 reads a color value corresponding to the CADD from color memory 63, stores the read color value CDATA in color cache memory 51 and simultaneously outputs the CDATA to perfragment unit 20. At step S100, arbiter 53 arbitrates the priority between the CPADD of cache controller 30 and the CADD of color cache controller 47 when the CPADD and the CADD are simultaneously output.

For example, when color cache controller 47 generates a cache hit when the depth/stencil value read and the color value stored changes during the pipeline operation such that color cache controller 47 generates a cache miss at the time of the color value read, and simultaneously the prefetch block 47 tries to prefetch a color value corresponding to the depth value, color cache controller 47 generates the CADD. Simultaneously, prefetch block 37 generates the CPADD. In this manner, arbiter 53 determines the priority between the CADD and the CPADD and may process the CADD earlier than the CPADD. When the depth value of the present fragment is smaller than that of the previous fragment, the perfragment unit 20 stores the depth value of the present fragment in depth/stencil cache memory 35. When the depth value of the present fragment is greater than that of the previous fragment, the perfragment unit 20 disposes the depth value of the present fragment. However, when a user selects a mode other than various depth test modes, the depth test is performed according to the selected mode.

When the depth test/stencil test of the present fragment passes, perfragment unit 20 transmits the present fragment to the next pipeline. Perfragment unit 20 outputs a variety of signals CREQ including a color request, a color address, and a read command associated with the present fragment to color cache controller 37. Perfragment unit 20 reads the CDATA corresponding to the CADD from color cache memory 51. While perfragment unit 20 performs the depth test of the present fragment, cache controller 30 reads a color value in advance corresponding to the depth value of the present fragment. The read color value is stored in color cache memory 51. Thus, the cache controller 30 can increase a cache hit rate during the blending operation. Perfragment unit 20 performs the alpha blending, logical operation, and dithering/color format conversion with respect to the color value read from color cache memory 51. The color value WCDATA is stored in color cache memory 51 according to the result of these operations. The invention may also be embodied as computer readable codes on a computer readable recording medium. The computer readable recording medium may be any data storage device that can read by a computer system.

As described above, in a method and apparatus for processing computer graphics data according to the present invention, since the color value used in the next pipeline can be prefetched while the perfragment unit performs a depth test, a cache miss generated in the color cache controller during the color blending operation can be reduced. In addition, since the color value of the present fragment can be prefetched in advance while the depth/stencil value read, depth test, stencil test, stencil operation, and depth value write of the present fragment are performed, the stall time associated with the pipeline of the perfragment unit can also be reduced. In this manner, stall time frequently generated in a 3D graphics pipeline caused by external memory access time of the color memory of a perfragment unit is concealed and the performance of the overall 3D graphics pipeline is improved. When a system bus supporting multiple outstanding transactions is used, the cache controller generates a color address simultaneously with the depth address output from the perfragment unit. When the color value corresponding to the color address is not stored in the color cache memory, the color address is output directly to the system bus so that a memory sub-system efficiently accesses a memory through DRAM bank interleaving. Accordingly, the memory access latency of the perfragment unit can be reduced by the effective external memory access.

Although the present invention has been described in connection with the embodiment of the present invention illustrated in the accompanying drawings, it is not limited thereto. It will be apparent to those skilled in the art that various substitutions, modifications and changes may be made thereto without departing from the scope and spirit of the invention.

What is claimed is:

1. A method for processing computer graphics data to reduce the external memory access time of a perfragment unit, said method comprising:
performing a depth test using said perfragment unit with respect to a present fragment of graphics data;
prefetching a color value of the present fragment from an external memory device; and
supplying said prefetched color value to a cache memory while the depth test of the present fragment is performed.

2. The method of claim 1 wherein the prefetching the color value of the present fragment comprises:
generating a prefetch color address based on a depth address of the present fragment and address conversion information supplied by said perfragment unit using a cache controller, said prefetch color address generated while said perfragment unit performs the depth test of the present fragment,
comparing a tag stored in said cache memory with the prefetch color address using said cache controller, and
prefetching the color value corresponding to the prefetch color address from the external memory device to the cache memory when said comparison results in a cache miss.

3. The method of claim 2 wherein said cache controller generates the prefetch color address based on the existence of a color operation, the depth address, and the address conversion information output from said perfragment unit.

4. The method of claim 2 wherein said cache controller generates the prefetch color address based on a result of the depth test of a previous fragment, the depth address, and the address conversion information.

5. A method for processing computer graphics data comprising:
receiving a color operation control signal output from a perfragment unit using a cache controller;
prefetching a color value of a present fragment from an external memory device based on the received color operation control signal and a prefetch color address while the perfragment unit performs a depth test or stencil test with respect to the present fragment; and
supplying said prefetched color value to a cache memory

6. The method of claim 5 wherein the color operation control signal is a signal indicating the performance of a blending operation.

7. The method of claim 5 wherein the color operation control signal indicates a result of a depth test of a previous fragment.

8. The method of claim 5 wherein the prefetching of the color value of a present fragment from an external memory device to a cache memory further comprises:
generating the prefetch color address based on a depth address of the present fragment and address conversion information using said cache controller;
comparing a tag stored in the cache memory with the prefetch color address using the cache controller;
outputting the prefetch color address to the external memory device when a cache miss occurs based on result of said comparison;
receiving the color value corresponding to the prefectch color address from the external memory device; and
storing the received color value in the cache memory using said cache controller.

9. The method of claim 5 wherein the address conversion information comprises at least one of depth value precision, stencil value precision, an offset of a depth memory of the external memory device, or an offset of a color memory of the external memory device.

10. An apparatus for processing computer graphics data comprising:
a perfragment unit performing a depth test with respect to a present fragment of graphics data;
a cache controller communicating with said perfragment unit, said cache controller configured to prefetch a color value of the present fragment from an external memory device; and
a cache memory configured to receive said color value from said cache controller while said perfragment unit performs the depth test of the present fragment.

11. The apparatus of claim 10, wherein said cache controller further comprises:
a prefetch color address generator generating a prefetch color address based on a depth address of the present fragment and address conversion information output from said perfragment unit; and
a determination block determining whether a cache hit or a cache miss occurs based on a comparison of a tag stored in said cache memory and said prefetch color address, said determination block controlling the transmission of said prefetch color address to the external memory device when the cache miss occurs.

12. The apparatus of claim 10 wherein said cache controller comprises:
a prefetch color address generator generating a prefetch color address based on a depth address with respect to the present fragment and address conversion information output from said perfragment unit;
a storing device storing a result of the depth test of a previous fragment;
a determination block determining whether a cache hit or a cache miss occurs based on a comparison of a tag stored in the cache memory and the prefetch color address; and
a transmission control block connected to the determination block and controlling whether to transmit the prefetch color address to the external memory device based on the result of the depth test stored in the storing device and the result from said determination block.

13. The apparatus of claim 10 wherein the cache controller comprises:
a prefetch color address generator generating a prefetch color address based on a depth address and address conversion information with respect to the present fragment;
a storing device storing a result of the depth test of a previous fragment;
a determination block communicating with said prefetch color address generator, said determination block configured to determine whether a cache hit or a cache miss occurs based on a tag stored in the cache memory or the prefetch color address; and
a transmission control block connected to the determination block, said transmission control block configured to control whether to transmit the prefetch color address to the external memory device, based on the result of the depth test stored in the storing device, a determining result of the determination block, and performance of color blending output from the perfragment unit.

14. The apparatus of claim 11 wherein the cache controller further comprises an arbiter communicating with said determination block, said arbiter configured to arbitrate a priority between the prefetch color address output from said determination block and a color address output from said cache memory.
